(19) United States
(12) Patent Application Publication
(10) Pub. No.: US 2012/0028151 A1
(43) Pub. Date: Feb. 2, 2012

(54) METHOD FOR FUEL CELL SYSTEM CONTROL AND A FUEL CELL SYSTEM USING THE SAME

(75) Inventors: Shih-Wei Lin, Taipei City (TW); Charn-Ying Chen, Taoyuan City (TW); Chih-Lin Huang, Taipei City (TW)

(73) Assignee: Institute of Nuclear Energy Research Atomic Energy Council, Executive Yuan, Taoyuan County (TW)

(21) Appl. No.: 12/893,343

(22) Filed: Sep. 29, 2010

(30) Foreign Application Priority Data
Jul. 28, 2010 (TW) 099124904

(51) Int. Cl. H01M 8/04; H01M 8/24

(52) U.S. Cl. 429/431

(57) ABSTRACT

A method is provided for fuel cell system control. In this method, the operation of a fuel cell system is divided into several modes, and the operation mode of the fuel cell system can be decided according to voltage signals, current signals and temperature signals of the fuel cell system. Moreover, a fuel cell system using this control method is also provided.

### BACKGROUND OF THE INVENTION

1. Field of Invention

The present invention relates to a method for fuel cell system control and a fuel cell system using the same. In this control method, the operation of a fuel cell system is divided into several modes, and the operation of a fuel cell system mode is decided according to voltage signals, current signals and temperature signals of the fuel cell system.

2. Related Art

To tackle the problems of running short of oil and global warming, the research and development and application of the alternative energies have attracted much attention from all countries, and among them, hydrogen energy is the most important. The fuel cell has the high energy conversion efficiency and the by-product is the clean and pollution-free water, which are the key purposes of developing hydrogen energy.

The power supply process of the fuel cell system involves the collocation of sub-systems like heat management, water management, fuel supply and electric power adjustment and control, and the fuel cell also relates to the reaction temperature, reaction concentration, output voltage and output current. The effective management of electric power energy can extend the using time and provide the stable electric power supply of electronic devices using electric energy (e.g. notebook computers and mobile phones). Therefore, it has not been disclosed in the prior art that in the application of fuel cell, how to effectively manage the operation of the fuel cell system to realize the control of the fuel cell system and keep the fuel cell system operating in an optimal state so as to improve the performance, reliability and lifespan.

Generally speaking, the output voltage and output current of the fuel cell are greatly influenced by the load, and according to the polarization curve of fuel cell, when the need for output current is increased, the output voltage is reduced and on the contrary, when the need for output current is reduced, the output voltage is increased. Furthermore, when the fuel cell is applied for dynamic load, if the time of load variation is too short, the fuel cell is limited by the reaction mechanism, and cannot provide enough power to the load in a transient time, which results in the insufficient electric power or unstable electric power. Therefore, in the prior art, the fuel cell system is provided with at least one auxiliary battery (secondary battery) to solve the problems of insufficient electric power or unstable electric power. However, if the swing of the operating voltage is too violent or the operating voltage changes too frequently, the fuel cell and the auxiliary battery are deteriorated earlier than expected.

In view of the above defects of the fuel cell system and in consideration of the importance of the management of electric power energy for the fuel cell system, the inventor of the present invention proposes a method for fuel cell system control and a fuel cell system using this control method.

### SUMMARY OF THE INVENTION

The present invention is directed to a method for fuel cell system control. In this method, the operation of a fuel cell system is divided into several modes, and the operation mode of the fuel cell system can be decided according to voltage signals, current signals and temperature signals of the fuel cell system.

To achieve the above objective of the present invention, the present invention also provides a fuel cell system for implementing the method of fuel cell system control of the present invention.

### BRIEF DESCRIPTION OF THE DRAWINGS

The present invention will become more fully understood from the detailed description given herein below for illustration only, and thus are not limitative of the present invention, and wherein:

FIG. 1 includes FIG. 1A and FIG. 1B, which are flow charts of switching between four working modes according to the magnitude of I_{load}, V₁, V₂ in a steady mode according to the method of fuel cell system control of the present invention;

FIG. 2 is a flow chart of switching operation modes according to the method of fuel cell system control of the present invention; and

FIG. 3 is an architectural view of a fuel cell system for implementing the method of fuel cell system control of the present invention.

### DETAILED DESCRIPTION OF THE INVENTION

To make the features, objectives and functions of the present invention more apparent, the related procedures, structural details and design concept of the present invention are illustrated in the embodiments with reference to the accompanying drawings, so that the Examiners may understand the characteristics of the present invention.

In the method of fuel cell system control of the present invention, the operation of a fuel cell system is divided into several modes, which includes: four operation modes of the fuel cell system and four working modes of the fuel cell stack. The fuel cell system at least includes: a fuel cell stack, a balance of plant (hereinafter referred to as BOP for short), a first voltage regulator circuit, a second voltage regulator circuit, a first auxiliary battery, a second auxiliary battery and a system load. Herein, the first voltage regulator circuit regulates an output voltage of a fuel cell to a voltage that can be used by the auxiliary batteries and the system load; when the second voltage regulator circuit is powered on, the voltage of the first auxiliary battery is converted by the first voltage regulator circuit and the second voltage regulator circuit, and then is supplied for the operation of the BOP; the BOP provides air and fuels for the fuel cell, and includes components for assisting operation, for example, a pump, a fan, an energy management system (EMS), a system central processing unit (CPU), and a detection unit. The detection unit detects a use current of the system load, a working voltage of the first auxiliary battery, a working voltage of the second auxiliary battery, an output current of the fuel cell stack through the first voltage regulator circuit, a temperature of the fuel cell stack, and the environment temperature, and provides the detected data to the system CPU for logic judgment. The system CPU at least includes a timer. Next, the operation modes are illustrated with reference to the working flows:

(1) Start: a start action, which starts a switching device of a power-on device of the fuel cell system to turn the system into the ON state; after the start, it is firstly determined whether the system uses the load and whether the electric power of the auxiliary battery is sufficient. When the use current of the system load (I_{load}) is smaller than a minimal working current of the system load, the working voltage of the first auxiliary battery (V₁) and the working voltage of the second auxiliary battery (V₂) are greater than a discharge setting value, and the environment temperature (Tₑₙ) is higher than 0° C., the fuel cell stack enters a sleep mode; if any of the above conditions is not satisfied, the fuel cell system enters a power-on mode. Herein, the minimal working current of the system load is defined as a threshold of minimal current of the system load set by the system; when the current of the system load is lower than the threshold, the system load does not operate, and the fuel cell stack in the fuel cell system stops outputting power.

(2) Sleep mode: in the sleep mode, the BOP is set to stop working, which further makes the fuel cell stack in the fuel cell system stop outputting power and at this time, only the CPU of the whole system continues operating (the electric power is provided by an auxiliary battery) and continuously measures I_{load}, V₁, V₂ and Tₑₙ. When I_{load} is greater than the minimal working current of the system load, or when V₁ or V₂ is smaller than the discharge setting value, or when Tₑₙ is lower than 0° C., the fuel cell system enters the power-on mode.

(3) Power-on mode: in the power-on mode, determination is made according to the measured temperature of the fuel cell stack (T_{fc}), if T_{fc} is lower than a start working temperature of the fuel cell stack, the fuel cell stack enters a temperature rising step and determines T_{fc} continuously; when T_{fc} is higher than the start working temperature, the fuel cell system enters a steady mode. Herein, the start working temperature of the fuel cell stack is defined as a lowest temperature at which chemical reaction takes place in the fuel cell stack and the current is output stably.

(4) Steady mode: in the steady mode of the fuel cell system, the electric power generated by the fuel cell stack is switched between the following four working modes according to I_{load}, V₁, V₂ for charging the auxiliary battery or for use by the system load. In the steady mode, it is continuously observed whether V₁ or V₂ is smaller than the discharge setting value or is greater than the charge setting value and whether a current (Iₒᵤₜ) output by the fuel cell stack through the first voltage regulator circuit is smaller than the minimal output current. Herein, the minimal output current is a threshold of output current of the system set by the user, and when the output current of the system is smaller than the threshold, it is defined that the electric power supply needed by the load is reduced. When Iₒᵤₜ is smaller than the minimal output current, and V₁ and V₂ are both greater than the charge setting value, the fuel cell system enters the standby mode; if any of the above conditions is not satisfied, the fuel cell system remains in the steady mode. Next, the four working modes are illustrated:

(A) Working mode A: the fuel cell stack connects to the second auxiliary battery to provide the charging electric power, and the first auxiliary battery provides electric power for use by the load and BOP. At this time, the second auxiliary battery only receives the electric power of the fuel cell stack to perform charging, and the first auxiliary battery provides electric power for use by the load and BOP. When V₂ is greater than the charge setting value or V₁ is smaller than the discharge setting value, the fuel cell stack is switched to the working mode B.

(B) Working mode B: the fuel cell stack connects to the first auxiliary battery to provide the charging electric power, and the second auxiliary battery provides electric power for use by the load and BOP. At this time, the first auxiliary battery only receives the electric power of the fuel cell stack to perform charging, and the second auxiliary battery provides electric power for use by the load and BOP. When V₁ is greater than the charge setting value or V₂ is smaller than the discharge setting value, the fuel cell stack is switched to the working mode A.

(C) Working mode C: in the working mode A or B, when I_{load} is greater than the current setting value of the system load and it is determined that I_{load} is not an instaneous high current variation but a continuous high current demand after a period of monitoring, a working mode C is provided, in which the fuel cell stack and one of the auxiliary batteries are connected in parallel to provide electric power for use by the system load and BOP. Herein, the current setting value of the system load is a current threshold of the system load set by the user, and when the current of the system load exceeds the threshold, it is determined that the system load is used with a high current. If I_{load} is much greater than twice of the current setting value of the system load, the fuel cell stack enters the working mode D. If I_{load} is smaller than the current setting value of the system load, the fuel cell stack returns to the working mode A or B.

(D) Working mode D: in the working mode D, since I_{load} is much greater than twice of the current setting value of the system load, the electric power of the fuel cell stack and the first and second auxiliary batteries connected in parallel is directly provided for use by the system load and BOP. If I_{load} is only greater than once of the current setting value of the system load, the fuel cell stack returns to the working mode C; if I_{load} is smaller than the current setting value of the system load, the fuel cell stack returns to the working mode A or B.

(5) Standby mode: after the fuel cell system enters the standby mode, the electric power of the fuel cell is only provided for BOP operation, and I_{load}, V₁ and V₂ are continuously observed. When I_{load} is smaller than the minimal working current of the system load, and V₁ and V₂ are greater than the discharge setting value, the timer of the CPU starts timing; if any of the above conditions is not satisfied, the fuel cell system returns to the steady mode. If the timer of CPU starts timing, the count up time is greater than a set time for entering the sleep mode, and the environment temperature is higher than 0° C., the fuel cell system enters the sleep mode; if the count up time of the timer of the CPU is smaller than the set time for entering the sleep mode, the fuel cell system remains in the standby mode.

Next, the implementation of the method of fuel cell system control of the present invention is illustrated with reference to an embodiment.

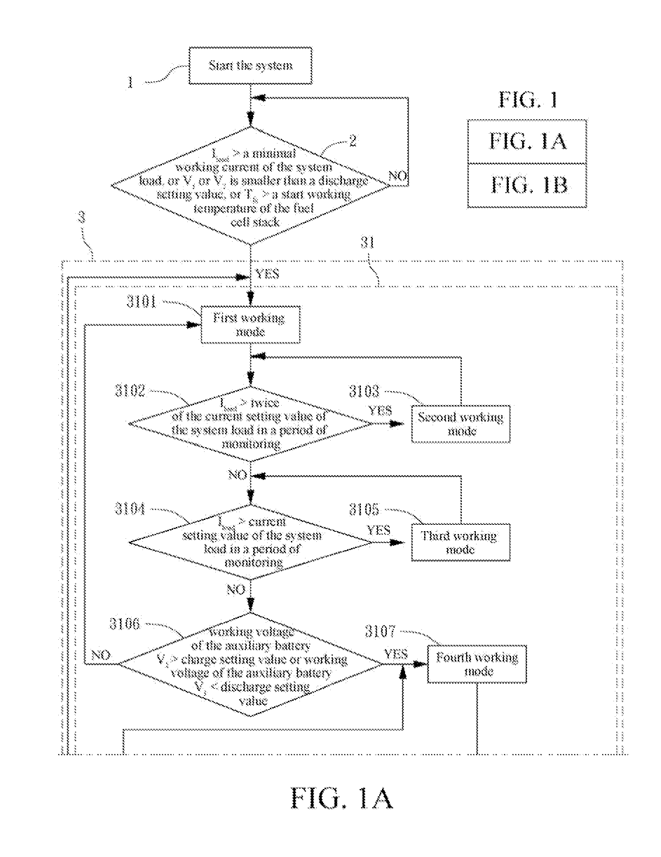

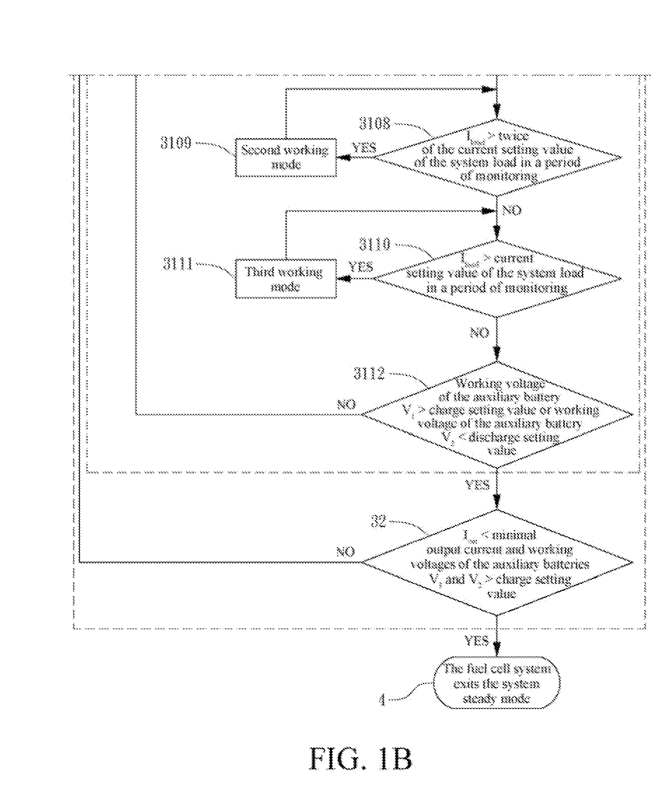

FIG. 1 includes FIG. 1A and FIG. 1B, which are flow charts of switching between four working modes in a steady mode according to the method of fuel cell system control of the present invention. The method includes the following steps:

Step (1): start the system.

Step (2): determine whether I_{load} is greater than a minimal working current of the system load, or whether V₁ or V₂ is smaller than a discharge setting value, or whether T_{fc} is greater than a start working temperature of the fuel cell stack; if any of the conditions is satisfied, the system enters Step (3), and if all conditions are not satisfied, the system does not enter Step (3) and continuously measures I_{loud}, V₁, V₂ and T_{fc} to perform the determination of the conditions;

Step (3): the fuel cell system enters the system steady mode;

Step (31): switch between four working modes of the fuel cell stack in the system steady mode according to I_{loud}, V₁, V₂;

Step (32): determine whether Iₒᵤₜ of the fuel cell stack is smaller than the minimal output current, and whether V₁ and V₂ are greater than the charge setting value; if all conditions are satisfied, perform Step (4), and if any of the conditions is not satisfied, return to Step (31);

Step (4): the fuel cell system exits the system steady mode.

Step (31) of switching between four working modes of the fuel cell stack in the system steady mode according to the I_{loud}, V₁, V₂ further includes the following steps:

Step (3101): the fuel cell stack enters the first working mode and performs Step (3102), in which the first working mode is the working mode A;

Step (3102): determine whether I_{load} is continuously greater than twice of the current setting value of the system load in a period of monitoring time; if yes, the fuel cell system enters Step (3103), if no, the fuel cell system enters Step (3104);

Step (3103): the fuel cell stack enters the second working mode and meanwhile performs determination of Step (3102), in which the second working mode is the working mode D;

Step (3104): determine whether I_{load} is continuously greater than the current setting value of the system load in a period of monitoring; if yes, the fuel cell system enters Step (3105), if no, the fuel cell system enters Step (3106);

Step (3105): the fuel cell stack enters the third working mode and meanwhile performs determination of Step (3104), in which the third working mode is the working mode C;

Step (3106): determine whether V₂ is greater than the charge setting value or whether V₁ is smaller than the discharge setting value; if all conditions are satisfied, the fuel cell system enters Step (3107), and if any of the conditions is not satisfied, the fuel cell system returns to Step (3101);

Step (3107): the fuel cell stack enters the fourth working mode and performs determination of Step (3108), in which the fourth working mode is the working mode B;

Step (3108): determine whether I_{load} is continuously greater than twice of the current setting value of the system load in a period of monitoring; if yes, the fuel cell system enters Step (3109), and if no, the fuel cell system enters Step (3110);

Step (3109): the fuel cell stack enters the second working mode and meanwhile performs determination of Step (3108);

Step (3110): determine whether I_{load} is continuously greater than the current setting value of the system load in a period of monitoring; if yes, the fuel cell system enters Step (3111), and if no, the fuel cell system enters Step (3112);

Step (3111): the fuel cell stack enters the third working mode and meanwhile performs determination of Step (3110);

Step (3112): determine whether V₁ is greater than the charge setting value or whether V₂ is smaller than the discharge setting value, if all conditions are not satisfied, the fuel cell system returns to Step (3107), if any of the conditions is satisfied, the fuel cell system performs Step (32);

Step (32): determine whether Iₒᵤₜ is smaller than the minimal output current, and whether V₁ and V₂ are greater than the charge setting value; if any of the conditions is not satisfied, return to Step (3101), and if all conditions are satisfied, perform Step (4).

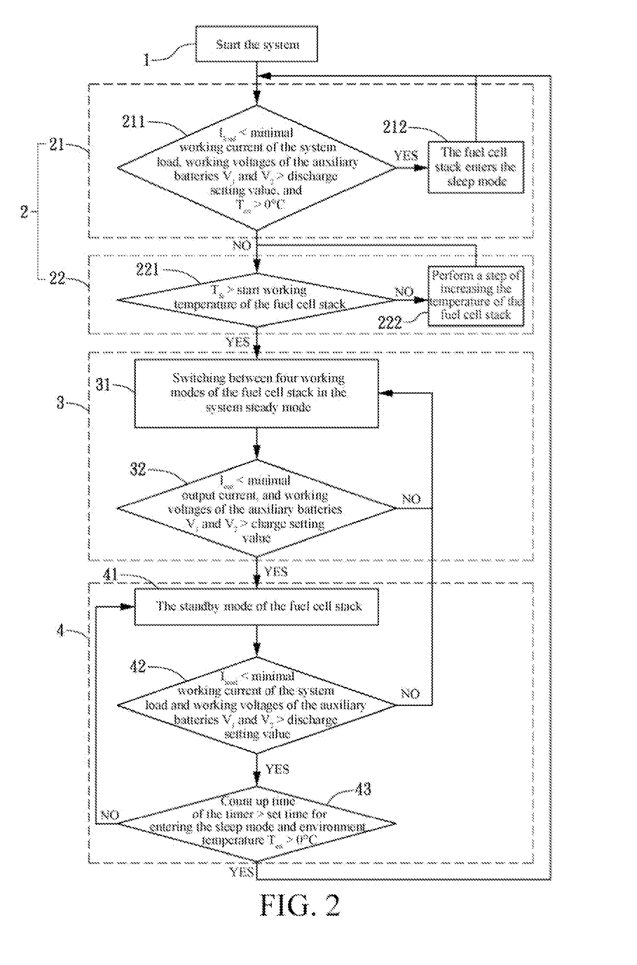

FIG. 2 is a flow chart of switching operation modes according to the method of fuel cell system control of the present invention.

As shown in FIGS. 1 and 2, preferably, Step (2) of FIG. 1 further includes the following steps:

Step (21): the fuel cell system enters the system sleep mode, and at this time the system may perform the following steps:

Step (211): determine whether I_{load} is smaller than the minimal working current of the system load, whether V₁ and V₂ are greater than the discharge setting value, and whether Tₑₙ is higher than 0° C.; if any of the conditions is not satisfied, the system enters Step (22), and if all conditions are satisfied, the system enters Step (212);

Step (212): the fuel cell stack enters the sleep mode, and at this time, I_{loud}, V₁, V₂ and Tₑₙ are measured continuously to perform determination of Step (211);

Step (22): the fuel cell system enters the system power-on mode, and at this time the system performs the following steps:

Step (221): determine whether T_{fc} is greater than the start working temperature of the fuel cell stack; if yes, the system enters Step (3), and if no, the system enters Step (222);

Step (222): perform a step of increasing the temperature of the fuel cell stack, and continuously measure T_{fc} to perform determination of Step (221).

The operation and function of Step (3) in FIG. 2 are the same as those of Step (3) in FIG. 1, so the details will not be repeated.

As shown in FIGS. 1 and 2, preferably, Step (4) of FIG. 1 further includes the following steps:

Step (41): the system enters the standby mode of the fuel cell stack, and Step (42) is performed;

Step (42): determine whether I_{load} is smaller than the minimal working current of the system load, and whether V₁ and V₂ are greater than the discharge setting value; if any of the conditions is not satisfied, the system returns to Step (31), and if all conditions are satisfied, the system enters Step (43);

Step (43): the timer of system CPU starts timing, and determines whether the count up time of the timer is greater than a set time for entering the sleep mode, and whether Tₑₙ is higher than 0° C.; if all conditions are satisfied, the system returns to Step (2), and if any of the conditions is not satisfied, the system returns to Step (41).

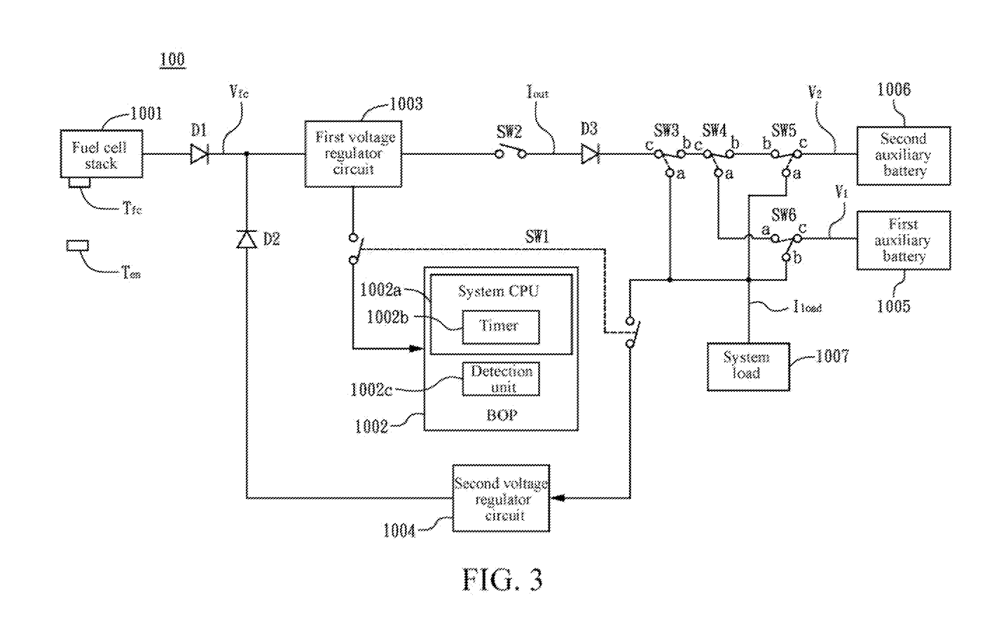

FIG. 3 is an architectural view of a fuel cell system for implementing the method of fuel cell system control of the present invention. As shown in FIG. 3, the fuel cell system 100 includes: a fuel cell stack 1001, a BOP 1002, a first voltage regulator circuit 1003, a second voltage regulator circuit 1004, a first auxiliary battery 1005, a second auxiliary battery 1006, a system load 1007, and at least six switching devices SW1˜SW6. The first voltage regulator circuit 1003 regulates the output voltage of the fuel cell stack 1001 to a voltage that can be used by the auxiliary batteries 1005, 1006 and the system load 1007; when the second voltage regulator circuit 1004 is powered on, the voltage of the first auxiliary battery 1005 is converted by the first voltage regulator circuit 1003 and the second voltage regulator circuit 1004, and then supplied for the operation of the BOP 1002; the BOP 1002 at least provides air and fuels for the fuel cell and includes components for assisting operation, for example, a pump, a fan, an energy management system (EMS), a system CPU 1002a and a detection unit 1002c and the like (in which the pump, fan and energy management system are not shown in the figure), and the functions and operation thereof have been disclosed in the prior art, so the details will not be repeated herein. The detection unit 1002c may detect I_{load}, V₁, V₂, Iₒᵤₜ, T_{fc} and Tₑₙ, and provides the detected data to the system CPU 1002a for logic judgment; the system CPU 1002a includes a timer 1002b; the at least six switching devices SW1˜SW6 are used for starting the system, shutting down the system, and serving as turn-on switching of the system circuitry when switching the operation modes of the system, in which, the switching device SW1 is the system power-on device, and the switching devices SW3˜SW6 each has three contacts a, b, c.

The operation of the fuel cell system 100 is illustrated with reference to the switching flow charts of FIGS. 1 and 2.

In Step (1), after the switching device SW1 is conducted, the system is in the ON state, and at this time, the fuel cell system 100 is started;

In Step (3), after the switching device SW2 is conducted, the fuel cell system 100 enters the system steady mode;

In Step (31), the switching devices SW3˜SW6 may switch between four working modes according to I_{load}, V₁, V₂ in the steady mode:

In Step (3101), the contacts b and c of the switching devices SW3˜SW6 are conducted, and the fuel cell stack enters the first working mode;

In Step (3103), the contacts a and c of the switching devices SW3, SW5, SW6 are conducted, and the fuel cell stack enters the second working mode;

In Step (3105), the contacts a and c of the switching device SW3 are conducted, and the fuel cell stack enters the third working mode;

In Step (3107), the contacts b and c of the switching device SW3 are conducted, and the contacts a and c of the SW4˜SW6 are conducted, and the fuel cell stack enters the fourth working mode;

In Step (3109), the contacts a and c of the switching devices SW3, SW5, SW6 are conducted, and the fuel cell stack enters the second working mode;

In Step (3111), the contacts a and c of the switching device SW3 are conducted, and the fuel cell stack enters the third working mode;

In Step (41), the switching devices SW2 is not conducted, and the fuel cell system 100 enters the standby mode of the fuel cell stack.

The fuel cell system 100 of the present invention may further include at least three diodes D1˜D3, for limiting directions of currents. As shown in FIG. 3, the diode D1 is used for limiting the electric power of the fuel cell stack 1001 to be output to the outside only, and the electric power of the auxiliary battery 1005 or 1006 is limited by the diode D1 and cannot be reversely provided to the fuel cell stack 1001; the diode D2 limits the electric power of the auxiliary battery 1005 or 1006 to be transmitted to the first voltage regulator circuit 1003 through the second voltage regulator circuit 1004 and provides the electric power for the operation of BOP 1002, and the electric power of the fuel cell stack 1001 is limited by the diode D2 and cannot be reversely provided to the second voltage regulator circuit 1004; the electric power of the fuel cell stack 1001 is provided to the auxiliary battery 1005 or 1006 and the system load 1007 by the diode D3 through the first voltage regulator circuit 1003, and the diode D3 limits the electric power of the auxiliary battery 1005 or 1006 to be transmitted to the BOP 1002 through the first voltage regulator circuit 1003.

The preferred embodiments of the present invention have been disclosed in the above, but are not intended to limit the present invention, and those skilled in the art can make alternations and modifications without departing the spirit and scope of the present invention. Therefore, the protection scope of the present invention is defined by the appended claims.

What is claimed is:

1. A method for fuel cell system control, wherein the fuel cell system at least comprises a fuel cell stack, a balance of plant (BOP), a first voltage regulator circuit, a second voltage regulator circuit, a first auxiliary battery, a second auxiliary battery and a system load, and the BOP at least comprises a system central processing unit (CPU) and a detection unit; the detection unit detects a use current of the system load, a working voltage of the first auxiliary battery, a working voltage of the second auxiliary battery, a current output by the fuel cell stack through the first voltage regulator circuit, a temperature of the fuel cell stack and an environment temperature, and provides the detected data to the system CPU for logic judgment, and the system CPU comprises a timer, the control method comprising the following steps:
Step (1): start the fuel cell system;
Step (2): determine whether the use current of the system load is greater than a minimal working current of the system load, or whether the working voltage of the first auxiliary battery or the working voltage of the second auxiliary battery is smaller than a discharge setting value, or whether the temperature of the fuel cell stack is greater than a start working temperature of the fuel cell stack, if any of the conditions is satisfied, the system enters a system steady mode; and
Step (3): in the system steady mode, according to the use current of the system load, the working voltage of the first auxiliary battery and the working voltage of the second auxiliary battery, the fuel cell stack is switched between four working modes.

2. The method for fuel cell system control according to claim 1, wherein Step (3) further comprises the following steps:
Step (301): the fuel cell stack enters a first working mode and performs Step (302);
Step (302): determine whether the use current of the system load is continuously greater than twice of a current setting value of the system load in a period of monitoring; if yes, the fuel cell system enters Step (303), and if no, the fuel cell system enters Step (304);
Step (303): the fuel cell stack enters a second working mode and meanwhile performs determination of Step (302);
Step (304): determine whether the use current of the system load is continuously greater than the current setting value of the system load in a period of monitoring; if yes, the fuel cell system enters Step (305), and if no, the fuel cell system enters Step (306);
Step (305): the fuel cell stack enters a third working mode and meanwhile performs determination of Step (304);
Step (306): determine whether the working voltage of the second auxiliary battery is greater than a charge setting value or whether the working voltage of the first auxiliary battery is smaller than the discharge setting value; if all conditions are satisfied, the fuel cell system enters Step (307), if any of the conditions is not satisfied, the fuel cell system returns to Step (301);
Step (307): the fuel cell stack enters a fourth working mode and performs determination of Step (308);
Step (308): determine whether the use current of the system load is continuously greater than twice of the current setting value of the system load in a period of monitoring; if yes, the fuel cell system enters Step (309), and if no, the fuel cell system enters Step (310);
Step (309): the fuel cell stack enters the second working mode and meanwhile performs determination of Step (308);
Step (310): determine whether the use current of the system load is continuously greater than the current setting value of the system load in a period of monitoring; if yes, the fuel cell system enters Step (311), and if no, the fuel cell system enters Step (312);
Step (311): the fuel cell stack enters the third working mode and meanwhile performs determination of Step (310);
Step (312): determine whether the working voltage of the first auxiliary battery is greater than the charge setting value or whether the working voltage of the second auxiliary battery is smaller than the discharge setting value; if all conditions are not satisfied, the fuel cell system returns to Step (307), and if any of the conditions is satisfied, the fuel cell system performs Step (313);
Step (313): determine whether a current output by the fuel cell stack through the first voltage regulator circuit is smaller than a minimal output current and whether the working voltage of the first auxiliary battery and the working voltage of the second auxiliary battery are greater than the charge setting value; if any of the conditions is not satisfied, return to Step (301), and if all conditions are satisfied, perform Step (4); and
Step (4): the fuel cell system exits the system steady mode.

3. The method for fuel cell system control according to claim 2, wherein Step (2) further comprises the following steps:
Step (21): the fuel cell system enters a system sleep mode, and at this time the system performs the following steps:
Step (211): determine whether the use current of the system load is smaller than the minimal working current of the system load, whether the working voltage of the first auxiliary battery and the working voltage of the second auxiliary battery are greater than the discharge setting value, and whether the environment temperature is higher than 0° C.; if any of the conditions is not satisfied, the system enters Step (22), and if all conditions are satisfied, the system enters Step (212); and
Step (212): the fuel cell stack enters the sleep mode, and at this time continuously measures the use current of the system load, the working voltage of the first auxiliary battery, the working voltage of the second auxiliary battery and the environment temperature to perform determination of Step (211);
Step (22): the fuel cell system enters a system power-on mode, and at this time the system performs the following steps:
Step (221): determine whether the temperature of the fuel cell stack is higher than the start working temperature of the fuel cell stack; if yes, the system enters Step (3), and if no, the system enters Step (222); and
Step (222): perform a step of increasing the temperature of the fuel cell stack and continuously measure the temperature of the fuel cell stack to perform determination of Step (221).

4. The method for fuel cell system control according to claim 3, wherein Step (4) further comprises:
Step (41): the fuel cell system enters a fuel cell stack standby mode, and at this time the system performs Step (42);
Step (42): determine wither the use current of the system load is smaller than the minimal working current of the system load and whether the working voltage of the first auxiliary battery and the working voltage of the second auxiliary battery are greater than the discharge setting value; if any of the conditions is not satisfied, the system returns to Step (3), and if all conditions are satisfied, the system enters Step (43); and
Step (43): the timer of the system CPU starts timing, and determines whether a count up time of the timer is greater than a set time for entering the sleep mode and whether the environment temperature is higher than 0° C.; if all conditions are satisfied, the system returns to Step (2), and if any of the conditions is not satisfied, the system returns to Step (41).

5. The method for fuel cell system control according to claim 2, wherein:
in the first working mode, the fuel cell stack connects to the second auxiliary battery to provide a charging electric power, and the first auxiliary battery provides electric power for use by the system load and the BOP;
in the second working mode, electric power of the fuel cell stack and the first and second auxiliary batteries connected in parallel is directly provided for use by the system load and the BOP;
in the third working mode, the fuel cell stack and one of the auxiliary batteries are connected in parallel to provide electric power for use by the system load and the BOP; and
in the fourth working mode, the fuel cell stack connects to the first auxiliary battery to provide the charging electric power, and connects to the second auxiliary battery to provide electric power for use by the system load and the BOP.

6. A fuel cell system, comprising:
a fuel cell stack;
a system load;
a first auxiliary battery;
a second auxiliary battery;
a first voltage regulator circuit, for regulating an output voltage of the fuel cell stack to a voltage that can be used by the auxiliary batteries and the system load;
at least six switching devices, for starting the fuel cell system and serving as turn-on switching of system circuitry;
a balance of plant (BOP), at least comprising:
a system central processing unit (CPU), for making logic judgment according to received detected data signals and transmitting corresponding control signals according to the logic judgment, and the system CPU comprising a timer; and
a detection unit, for detecting a use current of the system load, a working voltage of the first auxiliary battery, a working voltage of the second auxiliary battery, a current output by the fuel cell stack through the first voltage regulator circuit, a temperature of the fuel cell stack and an environment temperature, and generating corresponding signals according to the detected data and transmitting the signals to the system CPU for the logic judgment; and
a second voltage regulator circuit, wherein when powered on, a voltage of the first auxiliary battery is converted by the first voltage regulator circuit and the second voltage regulator circuit and then supplied for operation of the BOP.

7. The fuel cell system according to claim 6, wherein the system CPU makes the logic judgment according to the detected data signals transmitted by the detection unit, and transmits the corresponding control signals to the switching devices according to the logic judgment, so as to complete a method of fuel cell system control, and the control method comprises the following steps:
Step (1): start the fuel cell system;
Step (2): determine whether the use current of the system load is greater than a minimal working current of the system load, or whether the working voltage of the first auxiliary battery or the working voltage of the second auxiliary battery is smaller than a discharge setting value, or whether the temperature of the fuel cell stack is greater than a start working temperature of the fuel cell stack; if any of the conditions is satisfied, the system enters a system steady mode; and
Step (3): in the system steady mode, according to the use current of the system load, the working voltage of the first auxiliary battery and the working voltage of the second auxiliary battery, the fuel cell stack is switched between four working modes.

8. The fuel cell system according to claim 7, wherein Step (3) further comprises the following steps:
Step (301): the fuel cell stack enters a first working mode and performs Step (302);
Step (302): determine whether the use current of the system load is continuously greater than twice of a current setting value of the system load in a period of monitoring; if yes, the fuel cell system enters Step (303), and if no, the fuel cell system enters Step (304);
Step (303): the fuel cell stack enters a second working mode and meanwhile performs determination of Step (302);
Step (304): determine whether the use current of the system load is continuously greater than the current setting value of the system load in a period of monitoring; if yes, the fuel cell system enters Step (305), and if no, the fuel cell system enters Step (306);
Step (305): the fuel cell stack enters a third working mode and meanwhile performs determination of Step (304);
Step (306): determine whether the working voltage of the second auxiliary battery is greater than a charge setting value or whether the working voltage of the first auxiliary battery is smaller than the discharge setting value; if all conditions are satisfied, the fuel cell system enters Step (307), and if any of the conditions is not satisfied, the fuel cell system returns to Step (301);
Step (307): the fuel cell stack enters a fourth working mode and performs determination of Step (308);
Step (308): determine whether the use current of the system load is continuously greater than twice of the current setting value of the system load in a period of monitoring; if yes, the fuel cell system enters Step (309), and if no, the fuel cell system enters Step (310);
Step (309): the fuel cell stack enters the second working mode and meanwhile performs determination of Step (308);
Step (310): determine whether the use current of the system load is continuously greater than the current setting value of the system load in a period of monitoring; if yes, the fuel cell system enters Step (311), and if no, the fuel cell system enters Step (312);
Step (311): the fuel cell stack enters the third working mode and meanwhile performs determination of Step (310);
Step (312): determine whether the working voltage of the first auxiliary battery is greater than the charge setting value or whether the working voltage of the second auxiliary battery is smaller than the discharge setting value; if all conditions are not satisfied, the fuel cell system returns to Step (307), and if any of the conditions is satisfied, the fuel cell system performs Step (313);
Step (313): determine whether a current output by the fuel cell stack through the first voltage regulator circuit is smaller than a minimal output current, and whether the working voltage of the first auxiliary battery and the working voltage of the second auxiliary battery are greater than the charge setting value; if any of the conditions is not satisfied, return to Step (301), and if all conditions are satisfied, perform Step (4); and
Step (4): the fuel cell system exits the system steady mode.

9. The fuel cell system according to claim 8, wherein Step (2) further comprises:
Step (21): the fuel cell system enters a system sleep mode, and at this time the system performs the following steps:
Step (211): determine whether the use current of the system load is smaller than the minimal working current of the system load, whether the working voltage of the first auxiliary battery and the working voltage of the second auxiliary battery are greater than the discharge setting value, and whether the environment temperature is higher than 0° C.; if any of the conditions is not satisfied, the system enters Step (22), and if all conditions are satisfied, the system enters Step (212);
Step (212): the fuel cell stack enters the sleep mode, and at this time continuously measures the use current of the system load, the working voltage of the first auxiliary battery, the working voltage of the second auxiliary battery and the environment temperature to perform determination of Step (211);
Step (22): the fuel cell system enters a system power-on mode, and at this time the system performs the following steps:
Step (221): determine whether the temperature of the fuel cell stack is higher than the start working temperature of the fuel cell stack; if yes, the system enters Step (3), and if no, the system enters Step (222); and
Step (222): perform a step of increasing the temperature of the fuel cell stack and continuously measure the temperature of the fuel cell stack to perform determination of Step (221).

10. The fuel cell system according to claim 9, wherein Step (4) further comprises:
Step (41): the fuel cell system enters a fuel cell stack standby mode, and at this time the system performs Step (42);
Step (42): determine whether the use current of the system load is smaller than the minimal working current of the system load, and whether the working voltage of the first auxiliary battery and the working voltage of the second auxiliary battery are greater than the discharge setting value; if any of the conditions is not satisfied, the system returns to Step (3), and if all conditions are satisfied, the system enters Step (43); and
Step (43): the timer of the system CPU starts timing, and determines whether a count up time of the timer is greater than a set time for entering the sleep mode and whether the environment temperature is higher than 0° C.; if all conditions are satisfied, the system returns to Step (2), and if any of the conditions is not satisfied, the system returns to Step (41).

11. The fuel cell system according to claim 8, wherein:
in the first working mode, the fuel cell stack connects to the second auxiliary battery to provide a charging electric power, and the first auxiliary battery provides electric power for use by the system load and the BOP;
in the second working mode, electric power of the fuel cell stack and the first and second auxiliary batteries connected in parallel is directly provided for use by the system load and the BOP;
in the third working mode, the fuel cell stack and one of the auxiliary batteries are connected in parallel to provide electric power for use by the system load and the BOP; and
in the fourth working mode, the fuel cell stack connects to the first auxiliary battery to provide the charging electric power, and connects to the second auxiliary battery to provide electric power for use by the system load and the BOP.

12. The fuel cell system according to claim 11, further comprises at least three diodes, for limiting directions of currents.
